(19) United States
(12) Patent Application Publication
(10) Pub. No.: US 2020/0043297 A1
(43) Pub. Date: Feb. 6, 2020

(54) SYSTEM AND METHOD FOR HORSE RACE TIPPING

(71) Applicant: Travis Foelsch, Lake Arrowhead, CA (US)

(72) Inventor: Travis Foelsch, Lake Arrowhead, CA (US)

(21) Appl. No.: 16/514,705

(22) Filed: Jul. 17, 2019

Related U.S. Application Data
(60) Provisional application No. 62/714,484, filed on Aug. 3, 2018.

(51) Int. Cl. G07F 17/32; G06Q 50/34

(52) U.S. Cl. CPC G07F 17/3288; G07F 17/3223; G06Q 50/34

(57) ABSTRACT

A system for providing horse race tipping and bet ticketing is disclosed. The system comprises a provider submitting a plurality of tips corresponding to a sporting event and a content module publishing the tips on the user interface of a computing device. A ticket is then generated from user selections for a track, a race, a bet type, and a bet amount.

### CROSS-REFERENCE TO RELATED APPLICATIONS

The present invention claims priority to U.S. Provisional Application No. 62/714,484 filed on Aug. 3, 2018 entitled “Paperless Horse Race Tipping Sheet” the entire disclosure of which is incorporated by reference herein.

### TECHNICAL FIELD

The embodiments generally relate to a tip sheet application for sports betting and more specifically relates to a system for providing a paperless horse race tipping sheet.

### BACKGROUND

Sports betting is the activity of predicting sports results and placing a wager on the outcome. The majority of bets being placed are on American football, basketball, baseball, hockey, mixed martial arts, boxing, and horse racing at both the amateur and professional levels. Sports bettors place their wagers through a bookmaker or sportsbook which establishes the odds for each betting opportunity. Odds can be presented in various forms, often depending on the country in which the bet is placed.

Horse races may be done purely for sport, but often a major focus of horse racing's interest and economic importance is the gambling associated with it. Horse racing alone generates a worldwide market worth over $100 billion each year. Many bettors spend a significant amount of resources in research prior to placing a wager on a particular event. In particular, bettors spend time researching horses, the jockeys, and race conditions for a particular track on the day of the race. Some bettors pay for betting tips from an expert in the field, commonly referred to as tippers or tipsters.

### SUMMARY OF THE INVENTION

This summary is provided to introduce a variety of concepts in a simplified form that are further disclosed in the detailed description of the embodiments. This summary is not intended to identify key or essential inventive concepts of the claimed subject matter, nor is it intended for determining the scope of the claimed subject matter.

The embodiments described herein relate to a system for providing horse race tipping and bet ticketing comprising a provider submitting a plurality of tips corresponding to a sporting event and a content module publishing the tips on the user interface of a computing device. A ticket is then generated from user selections for a track, a race, a bet type, and a bet amount. Tickets may be automatically generated by the system corresponding to the user-selected parameters, or manually generated by the user.

The embodiments may be utilized by patrons of a sporting event, such as a horse racing track, to educate the patrons on participants of the sporting event, projected outcomes of the sporting event, and types of bets which may be placed. The system allows for paperless horse race tipping, whereas the current arts rely on paper tipping sheets provided at the sporting event venue. In such, the tipping sheet may be automatically updated by the provider in real-time.

In one aspect, a trivia module generates a trivia game and provides the trivia game to one or more of the users. The trivia module may transmit the trivia game only to the users in a predetermined geographic region, such as at a particular race track.

In one aspect, the bet amount is a budget for a user-selected amount of time, such as a single day at a particular race track.

In one aspect, the bet type is selected from the group consisting of: an exacta, a trifecta, a superfecta, a rolling double, a pick 3, a pick 4, a pick 5, a pick 6, a super hi-5, a win/show, a win/place/show, a win, a show, and a place.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an exemplary block diagram of the network infrastructure, according to some embodiments;

FIG. 2 illustrates a screenshot of the user interface, according to some embodiments;

FIG. 3 illustrates a screenshot of the track list, according to some embodiments;

FIG. 4 illustrates a screenshot of the race selection interface, according to some embodiments;

FIG. 5 illustrates a screenshot of the bet type interface, according to some embodiments;

FIG. 6 illustrates a screenshot of the betting amount interface, according to some embodiments;

FIG. 7 illustrates a screenshot of the card, according to some embodiments;

FIG. 8 illustrates a screenshot of the ticket generated by the ticket generation module, according to some embodiment;

FIG. 9 illustrates a block diagram of the server engine and modules, according to some embodiments;

FIG. 10 illustrates a flowchart for a method for creating a ticket for a sporting event, according to some embodiments; and

FIG. 11 illustrates a screenshot of the race tipping interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” relates to a person or persons which utilize the system to consume sport event information, including real-time event updates and information, wager tips and advice, wager tutorials, and similar information related to the sporting event (such as horse races).

As used herein, the term “provider” relates to a handicapper or tipper who utilizes the system to generate, publish, and edit content related to a sporting event including general information wager tips, handicaps, wager tutorials, and similar information related to the sporting event. For example, the provider may generate a digital horse race tipping sheet and publish the horse race tipping sheet for users to purchase. The horse race tipping sheet can include the providers projected winners for each race that day, or for future races.

In general, the embodiments provided herein relate to a sporting event tipping system which provides event information to potential bettors. The system permits handicappers and tippers to generate and publish tipping information for events, such as horse races, and amend or update their published information in real-time. The published tips are provided to potential bettors who may be required to pay for information produced by the handicappers and tippers. The system can be used to publish and consume information for horse tracks anywhere in the world. One skilled in the arts will readily understand that the system may be modified to various other forms of sports betting such as American football, basketball, baseball, mixed martial arts, boxing, hockey, and similar amateur and professional sports.

The embodiments provide a means for handicappers and tippers to easily update information they have published and display the updated information such that users can view the updated information. For example, if a horse scratches (makes a late decision to not run in a race) the tipper can amend their published information on the interactive digital platform.

In some embodiments, the system provides an interactive interface for teaching users how to bet on particular events. For example, horse racing operates on a complex betting system that is difficult to learn for many, resulting in apprehension and missed betting opportunities. The teaching system may use published content in the form of text, audio, and video with which they user can engage.

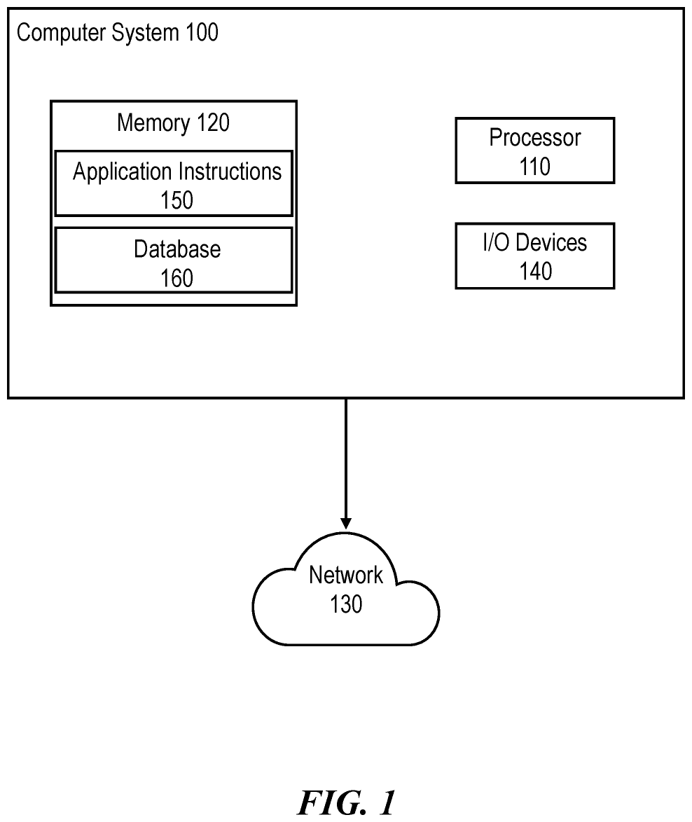

FIG. 1 illustrates a computer system 100, which may be utilized to execute the processes described herein. The computing system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.). The database 160 may store data including sporting event information including but not limited to event dates, event locations, weather conditions, betting and wager information, tipping information, tutorials, and projected outcomes for the events.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

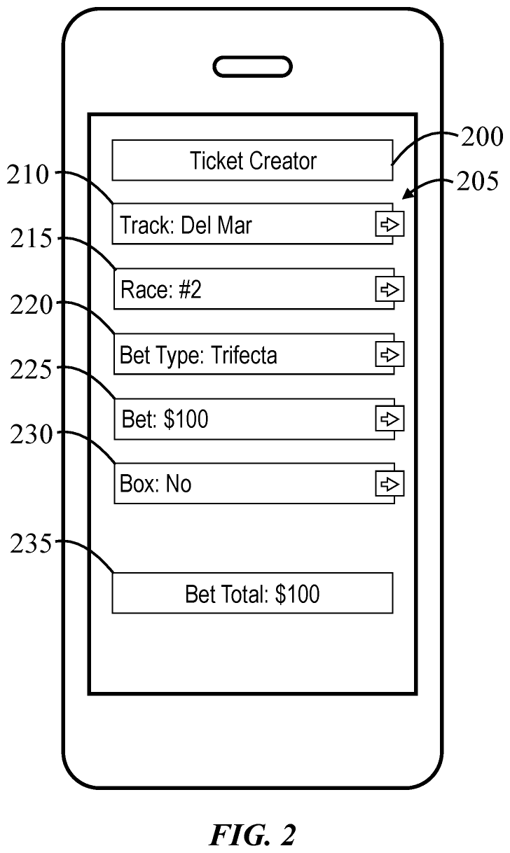

In reference to FIG. 2, an exemplary ticket generation interface 200 is illustrated. A plurality of menu items 205 are provided each having a plurality of selectable options. For example, the user can select a track 210, a race 215, a bet (or wager) type 220, bet amount 225, and a box option 230. The system automatically calculates a bet total 235 for the ticket which is then generated by a ticket generation module. Selecting any of the menu items 205 display a drop-down list of the options therein such as, for example, a list of each track 210 for which a ticket may be generated. The list of tracks may be updated in real-time to provide the user with options for races which are currently available for betting.

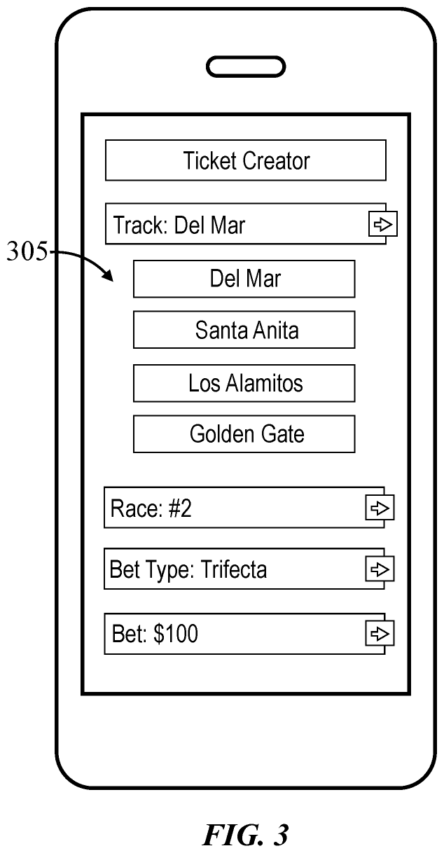

FIG. 3 illustrates the user interface and more specifically illustrates the drop-down track list 305 which provides selectable options for each of the tracks for which the user may create a ticket. Once the user has selected a track, such as Del Mar, the selection is transmitted to the ticket generation module.

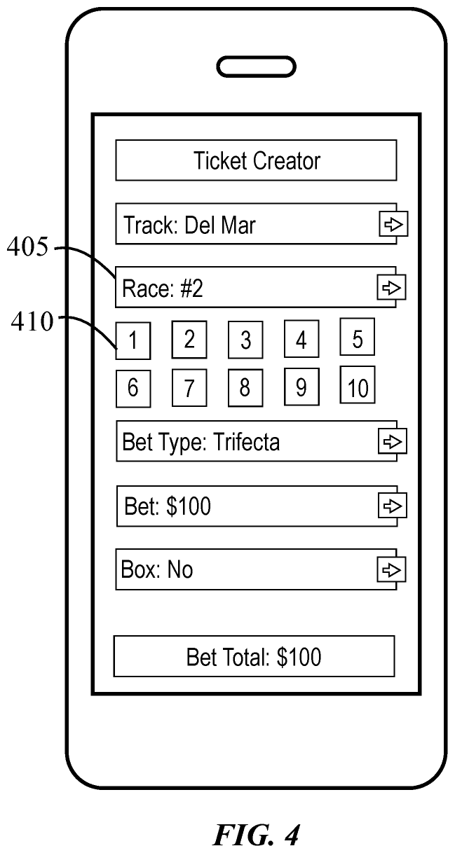

FIG. 4 illustrates the user interface, and more specifically illustrates the race selection interface 405 wherein the user selects a race number 410 related to the track selected in FIG. 3. The system may automatically update the race numbers throughout the day to only allow available races to be shown. Once the user has selected the race number 410, the system transmits the selection to the ticket generation module.

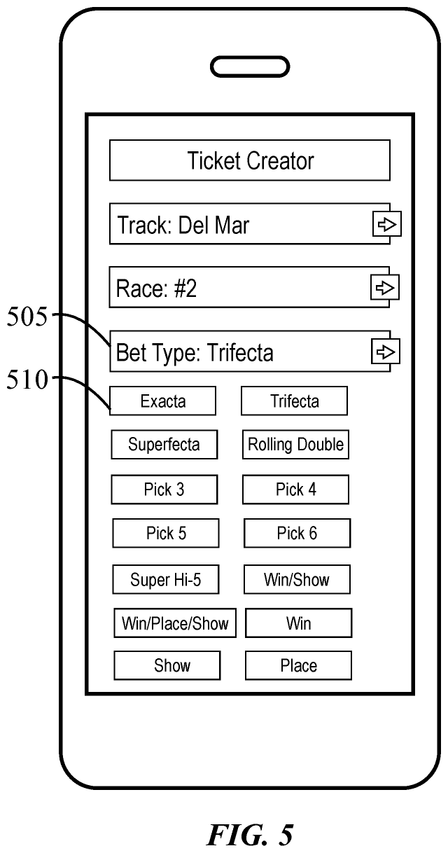

FIG. 5 illustrates the user interface, and more specifically illustrates the bet type interface 505 wherein the user selects a betting type 510 which may include but is not limited to exacta, trifecta, superfecta, rolling double, pick 3, pick 4, pick 5, pick 6, super hi-5, win/show, win/place, show, win, show, and place among other betting types known in the arts. One skilled in the arts will readily understand that other betting types may be utilized.

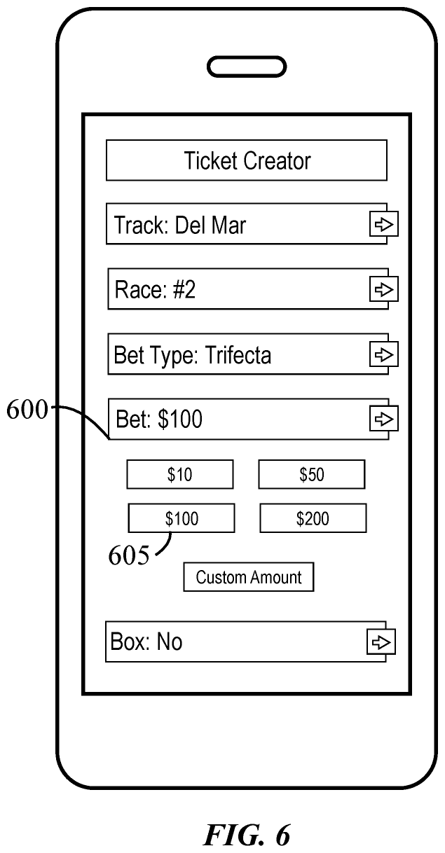

FIG. 6 illustrates the user interface, and more specifically illustrates the bet amount selection interface 600 wherein the user selects a bet amount 605 related to the track, race, and bet (or wager) type for a particular ticket. Alternatively, the user may select a bet threshold for a series of bets placed by the user such as, for example a $100 budget for the entire day of races. The system may then automatically generate a plurality of tickets for wagers that match the budget and projected outcomes given by the provider.

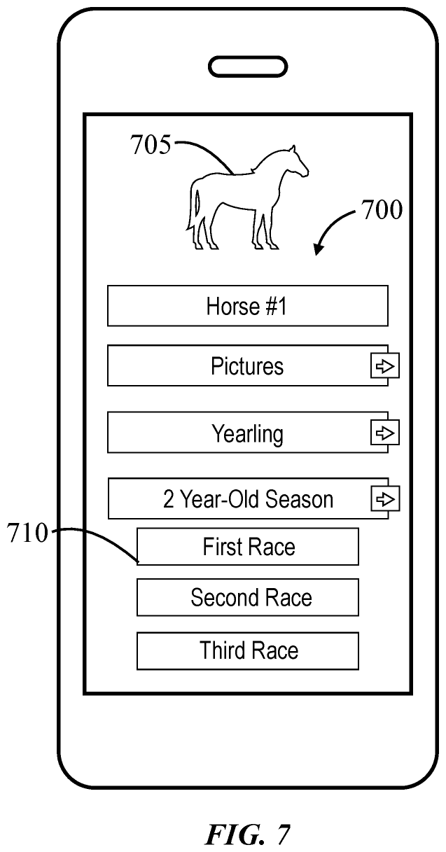

FIG. 7 illustrates a card 700 generated by the system. The card is generated by the card generation module and displays information related to a particular athlete, horse, event space, or other component of a sporting event. For example, the card 700 may be comprised of an image 705, and statistics 710 related to a particular horse. The card may also include images of the horse or athlete stored in the database, and selectable tabs for each event the horse or athlete has competed in.

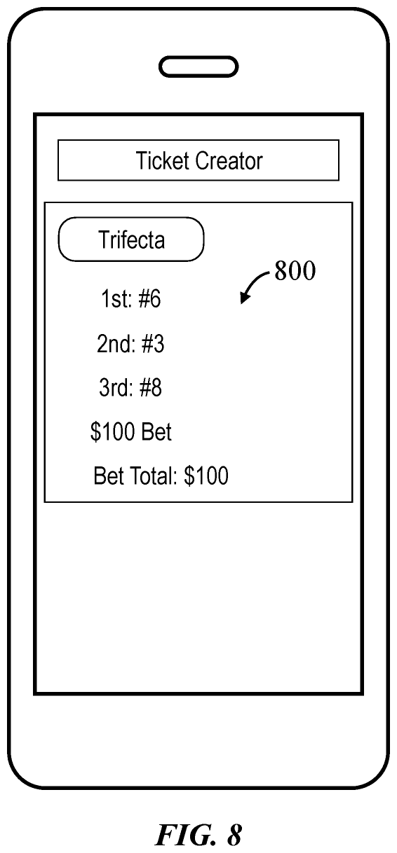

FIG. 8 illustrates an exemplary ticket 800 generated by the ticket generation module. The ticket 800 and information contained thereon may be manually selected by the user or automatically generated by the ticket generation module based on information received from the provider (such as projected outcomes for a race, suggested bet types and bet amounts. The system may provide means for transmitting the ticket to a sportsbook or be used as a reference when placing a bet at a racetrack.

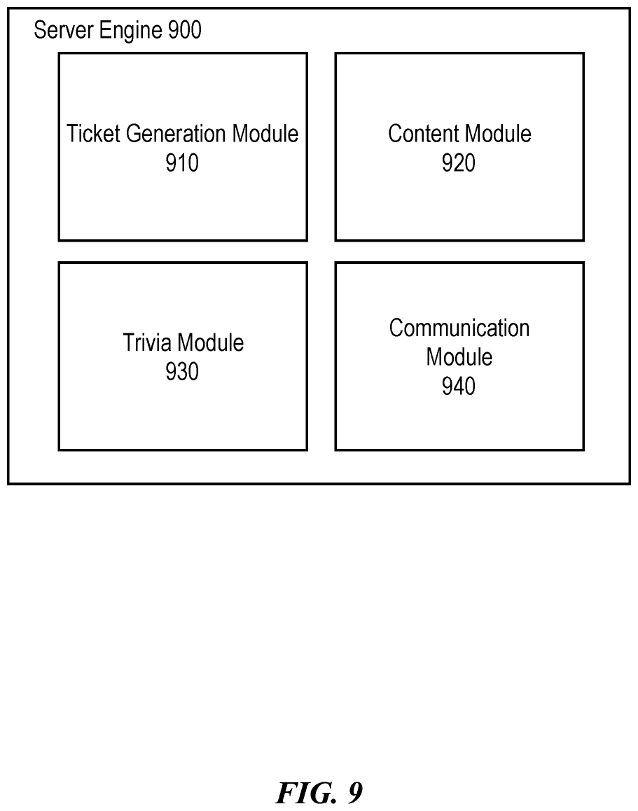

FIG. 9 illustrates an exemplary block diagram of the server engine 900 and modules to execute the functions described by the various embodiments. The ticket generation module 910 generates a ticket based on the users selected track, race, betting type, bet amount, and box number. The ticket may then be transmitted to the ticket receiving system for the bet to be placed at the racetrack or other sportsbook. A content module 920 provides a means for updating information provided by the provider or sporting event administrator. For example, the content module 920 may provide a means for the provider to update a tip if a horse has dropped out of a particular race. In another example, an administrator or external system may update weather information and times for a series of races. The updates are then published via the content module 920. A communication module 940 provides a means for users and providers to communicate with one another via the system.

In some embodiments, the content module 920 receives sporting event results via a network interface. Sporting event results may include real-time horse race leaderboards submitted by the sporting event administrator or provider. In such, users are provided with real-time information for a plurality of sporting events.

In some embodiments, the content module 920 may generate results for a ticket created for a bet placed by the user.

In some embodiments, and in further reference to FIG. 9, a trivia module 930 generates a trivia game, such as a series of questions, which is published and provided to the user via the content module 920. The trivia may be useful during down-time in between races. In one example, the trivia module 930 generates a trivia game comprised of a plurality of questions related to a sporting event. Each question is timed and requires the user to answer the question in a predetermined amount of time. Points may be awarded for correct answers and/or the speed in which the answer was submitted. Users within a geographic region may be grouped into a user community, such as users at a particular track on the day of a race.

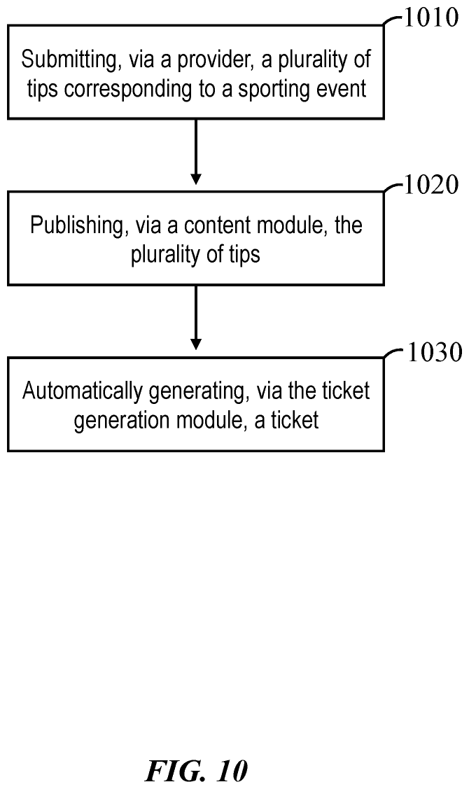

FIG. 10 illustrates a flowchart for a method for automatically generating a ticket for a sporting event. In step 1010, a provider submits a plurality of tips corresponding to the sporting event, such as horse race tips for a particular race. The content module then publishes the tips in step 1020 and a ticket generation module automatically generates the ticket in view of the horse race tips selected by the provider.

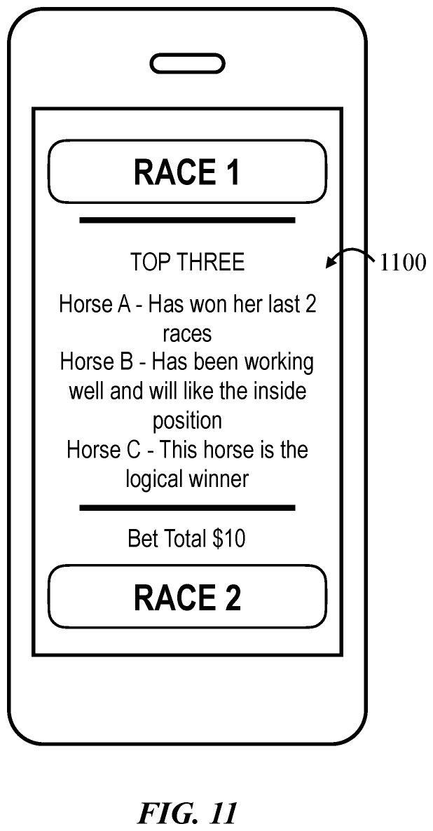

FIG. 11 illustrates a race tipping interface 1100 wherein a provider uploads tipping selections to the system. In the current arts, information for horse races is provided to potential bettors prior to each race which gives users little time to make an educated betting decision. The embodiments provided herein allow for horse race tipping to be provided to the user such that they may review the tipping information before the race. This gives users the advantage of having an extended period of time to make a betting decision before each race. The user may select each race to see provider information (such as projected winners, etc.).

In some embodiments, the provider may upload media which may include live or recorded video or audio streams of the sporting event. In one example, the provider uploads videos of horses before the race. The videos may be utilized by the user to aid in the selection of a horse race prior to placing a bet or wager.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for providing horse race tipping and bet ticketing, the system comprising:
a provider submitting a plurality of tips corresponding to a sporting event;
a content module publishing, via a user interface on a computing device, the plurality of tips; and
a user generating a ticket, via a ticket generation module, for the sporting event, the ticket indicating a bet selected by the user.

2. The system of claim 1, further comprising a trivia module to generate a trivia game and provide the trivia game to one or more of the users.

3. The system of claim 2, wherein the trivia module transmits the trivia game to the users in a predetermined geographic region.

4. The system of claim 1, wherein the ticket generation module generates the ticket from the user's selections for a track, a race, a bet type, and a bet amount.

5. The system of claim 4, wherein the bet amount is a budget for a user-selected amount of time.

6. The system of claim 4, wherein the bet type is selected from the group consisting of: an exacta, a trifecta, a superfecta, a rolling double, a pick 3, a pick 4, a pick 5, a pick 6, a super hi-5, a win/show, a win/place/show, a win, a show, and a place.

7. A system for providing horse race tipping and bet ticketing, the system comprising:
a provider submitting a plurality of tips corresponding to a sporting event;
a content module publishing, via a user interface on a computing device, the plurality of tips;
a user generating a ticket, via a ticket generation module, the ticket comprised of a track, a race, a bet type, and a bet amount.

8. The system of claim 7, wherein the ticket generation module automatically generates a ticket based on the plurality of tips submitted by the provider.

9. The system of claim 8, wherein the content module publishes a plurality of content related to the sporting event.

10. The system of claim 1, further comprising a trivia module to generate a trivia game and provide the trivia game to one or more of the users.

11. The system of claim 10, wherein the trivia module transmits the trivia game to the users in a predetermined geographic region.

12. The system of claim 7, wherein the ticket generation module generates the ticket from the user's selections for the track, the race, the bet type, and the bet amount.

13. The system of claim 12, wherein the bet amount is a budget for a user-selected amount of time.

14. The system of claim 13, wherein the bet type is selected from the group consisting of: an exacta, a trifecta, a superfecta, a rolling double, a pick 3, a pick 4, a pick 5, a pick 6, a super hi-5, a win/show, a win/place/show, a win, a show, and a place.

15. The system of claim 14, further comprising a plurality of tutorials submitted by the provider to teach the user the bet type.

16. The system of claim 15, wherein the tutorials are provided by the provider as a video.

17. A method for generating a ticket for a sporting event, the method comprising the steps of:
submitting, via a provider, a plurality of tips corresponding to a sporting event, the plurality of tips indicating a track, a race, a bet type, and a bet amount;
publishing, via a content module, the plurality of tips on the user interface of a computing device;
automatically generating, via a ticket generating module, a ticket comprised of the track, the race, the bet type, and the bet amount submitted by the provider.

18. The method of claim 17, further comprising a trivia module to generate a trivia game and provide the trivia game to one or more of the users.

19. The method of claim 18, wherein the trivia module transmits the trivia game to the users in a predetermined geographic region.

20. The method of claim 16, wherein the bet type is selected from the group consisting of: an exacta, a trifecta, a superfecta, a rolling double, a pick 3, a pick 4, a pick 5, a pick 6, a super hi-5, a win/show, a win/place/show, a win, a show, and a place.
